(19) United States
(12) Patent Application Publication
(10) Pub. No.: US 2025/0102968 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Hina SAITO, Kanagawa (JP); Takashi MATSUBARA, Kanagawa (JP); Takashi OHASHI, Kanagawa (JP); Takuma ISHIHARA, Kanagawa (JP); Sodai HIGUCHI, Kanagawa (JP)

(73) Assignee: FUJIFILM Business Innovation Corp., Tokyo (JP)

(21) Appl. No.: 18/443,800

(22) Filed: Feb. 16, 2024

(30) Foreign Application Priority Data
Sep. 26, 2023 (JP) 2023-163608

(51) Int. Cl. G03G 15/20; G03G 15/00

(52) U.S. Cl. CPC G03G 15/2017; G03G 15/2064; G03G 15/50; G03G 2215/2032

(57) ABSTRACT

A fixing device includes: a fixing belt that is heated by a heat source and rotates; a pressing roller that forms a nip part at a spot where the pressing roller is in contact with the fixing belt, the pressing roller rotating; and a load adjustment mechanism that obtains a belt temperature of the fixing belt and adjusts a load at the nip part according to a state of the belt temperature relative to a predetermined temperature.

### CROSS-REFERENCE TO RELATED APPLICATIONS

This application is based on and claims priority under 35 USC 119 from Japanese Patent Application No. 2023-163608 filed Sep. 26, 2023.

### BACKGROUND

### (i) Technical Field

The present disclosure relates to a fixing device and an image forming apparatus.

### (ii) Related Art

Japanese Unexamined Patent Application Publication No. 2005-300986 discloses a technique of driving a fixing belt by using a driving member that drives the fixing belt from the outer surface, in a region other than a contact nip region between the fixing belt and a heating roller, so as to provide a belt nip type fixing device enabling securing of glossy feeling of a toner image by securing the pressure at the contact nip region and, at the same time, enabling the stability of the transport of the belt by preventing the belt from slipping.

Japanese Unexamined Patent Application Publication No. 2007-121407 discloses a technique of suppressing an advance load that is applied to a nip forming member when a pressing member performs a movement operation of advance, so as to prevent loss of life to a fixing member, as a component, by decreasing a load applied to the fixing member.

### SUMMARY

A fixing device used for an image forming apparatus employs a technique of performing fixing processing by using a fixing belt imparted with tension by plural rollers and by using a pressing roller that is in contact with a pad part with the fixing belt interposed therebetween. In the technique, with increase in the temperature of the fixing belt, the fixing belt rotates with the rotation of the pressing roller.

In the technique, the pressing roller may rotate with the fixing belt that is dented or bent due to an insufficient increase of the temperature of the fixing belt. When the fixing belt is dented or bent as described above, a driving torque for rotating the fixing belt increases; thus, there arises a difference in rotation speed between the fixing belt and the pressing roller. When a difference in rotation speed between the fixing belt and the pressing roller arises, slipping is caused, and surfaces of the fixing belt and the pressing roller are damaged. For example, when another driving roller is externally provided to suppress the slipping, the size and the cost of the fixing device increase.

Aspects of non-limiting embodiments of the present disclosure relate to, without adding another roller, suppression of the slipping between a fixing belt and a pressing roller and reduction in the heating time of the fixing belt.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a fixing belt that is heated by a heat source and rotates; a pressing roller that forms a nip part at a spot where the pressing roller is in contact with the fixing belt, the pressing roller rotating; and a load adjustment mechanism that obtains a belt temperature of the fixing belt and adjusts a load at the nip part according to a state of the belt temperature relative to a predetermined temperature.

### BRIEF DESCRIPTION OF THE DRAWINGS

Exemplary embodiments of the present disclosure will be described in detail based on the following figures, wherein:

FIG. 1 illustrates an image forming apparatus according to the present exemplary embodiment;

FIG. 2 illustrates a fixing device according to the present exemplary embodiment; and

FIGS. 3A and 3B illustrate a procedure of adjustment of a load performed by a load adjustment mechanism according to the state of the temperature of a belt.

### DETAILED DESCRIPTION

Hereinafter, an exemplary embodiment of the present disclosure will be described in detail with reference to the accompanying drawings.

### Description of Image Forming Apparatus

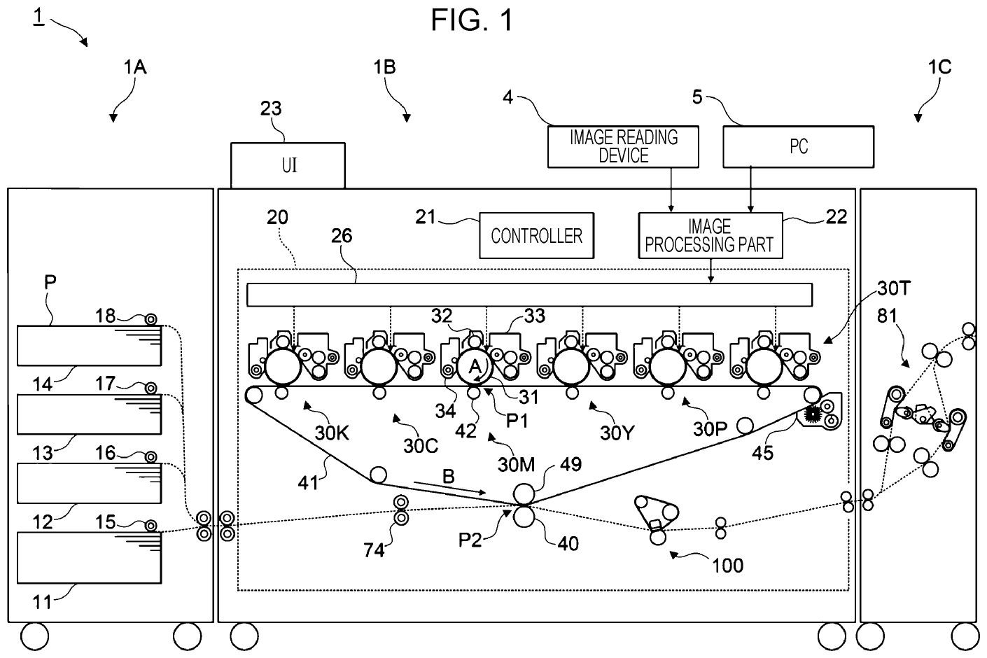

FIG. 1 illustrates an image forming apparatus 1 according to the present exemplary embodiment.

The image forming apparatus 1 according to the present exemplary embodiment includes a sheet feed section 1A, a printing section 1B, and a sheet discharge section 1C.

The sheet feed section 1A includes first to fourth sheet storages 11 to 14 storing paper sheets P that are each an example of a recording medium.

The sheet feed section 1A further includes delivery rollers 15 to 18 that are provided for the first to fourth sheet storages 11 to 14, respectively, and deliver the paper sheets P stored in the respective sheet storages to transport paths connected to the printing section 1B.

The printing section 1B includes an image forming part 20 that forms an image on a paper sheet P. The printing section 1B further includes a controller 21 that controls each part of the image forming apparatus 1.

The printing section 1B further includes an image processing part 22. The image processing part 22 performs image processing on the image data transmitted from an image reading device 4 or a personal computer (PC) 5.

The printing section 1B is further provided with a user interface (UI) 23 constituted by, for example, a touch panel, and the UI 23 provides notification of information for a user and receives an input of information from the user.

The image forming part 20 includes six image forming units 30T, 30P, 30Y, 30M, 30C, and 30K (hereinafter, sometimes referred to simply as “image forming units 30”) arranged in juxtaposition at regular spacings.

Each of the image forming units 30 includes a photoconductor drum 31 on which an electrostatic latent image is formed during the rotation of the photoconductor drum 31 in the direction of an arrow A, a charging roller 32 that charges a surface of the photoconductor drum 31, a developer 33 that develops the electrostatic latent image formed on the photoconductor drum 31, and a drum cleaner 34 that removes, for example, the toner on the surface of the photoconductor drum 31.

The image forming part 20 includes an exposure device 26 that exposes, with laser light, the photoconductor drum 31 provided in each of the image forming units 30.

Note that the exposure of the photoconductor drum 31 performed by the exposure device 26 is not limited to the exposure using the laser light. For example, a light source such as a light emitting diode (LED) may be provided for each of the image forming units 30, and the light emitted from the light source may be used to expose the photoconductor drum 31.

The image forming units 30 have similar configurations except for the toners stored in the developers 33. The image forming units 30Y, 30M, 30C, and 30K form toner images of respective colors: yellow (Y), magenta (M), cyan (C), and black (K).

The image forming units 30T and 30P form toner images with a toner for a corporate color, a foamable toner for braille, a fluorescent color toner, a toner for improving gloss, and other toners. In other words, the image forming units 30T and 30P form toner images of spot colors.

The image forming part 20 further includes an intermediate transfer belt 41 onto which toner images of the respective colors formed at the photoconductor drums 31 of the image forming units 30 are transferred.

The image forming part 20 further includes first transfer rollers 42 that transfer the toner images of the colors of the respective image forming units 30 onto the intermediate transfer belt 41 at a first transfer part P1.

The image forming part 20 further includes a second transfer roller 40 that collectively transfers the toner images that have been transferred onto the intermediate transfer belt 41, onto a paper sheet P at a second transfer part P2.

The image forming part 20 further includes a belt cleaner 45 that removes, for example, the toner on a surface of the intermediate transfer belt 41 and further includes a fixing device 100 that fixes the second-transferred images to a paper sheet P.

The image forming part 20 performs an image forming operation based on a control signal form the controller 21.

Specifically, in the image forming part 20, the image processing part 22 performs image processing on the image data input from the image reading device 4 or the PC 5, and the image data that have been subjected to the image processing is supplied to the exposure device 26.

For example, in the image forming unit 30M of magenta (M), after the charging roller 32 charges the surface of the photoconductor drum 31, the exposure device 26 irradiates the photoconductor drum 31 with the laser light that has been modulated based on the image data obtained from the image processing part 22.

Thus, an electrostatic latent image is formed on the photoconductor drum 31.

The formed electrostatic latent image is developed by the developer 33, and a toner image of magenta is formed on the photoconductor drum 31.

Similarly, in the image forming units 30Y, 30C, and 30K, the respective toner images of yellow, cyan, and black are formed, and, in the image forming units 30T and 30P, toner images of spot colors are formed.

The toner images of the respective colors formed at the image forming units 30 are electrostatically transferred, by the first transfer rollers 42, one by one, onto the intermediate transfer belt 41 rotating in the direction of an arrow B in FIG. 1 and are formed into superposed toner images on the intermediate transfer belt 41.

The superposed toner images formed on the intermediate transfer belt 41 are transported, with the movement of the intermediate transfer belt 41, to the second transfer part P2 constituted by the second transfer roller 40 and a backup roller 49.

On the other hand, the paper sheet P, for example, is taken out from the first sheet storage 11 by the delivery roller 15 and is then transported to the position of a resist roller 74 via the transport path.

When the superposed toner images are transported to the second transfer part P2, in accordance with the timing of the transport, the paper sheet P is supplied to the second transfer part P2 from the resist roller 74.

At the second transfer part P2, the superposed toner images are then electrostatically transferred in a collective manner onto the paper sheet P by the action of the transfer electric field that is formed between the second transfer roller 40 and the backup roller 49.

Subsequently, the paper sheet P onto which the superposed toner images have been electrostatically transferred is transported to the fixing device 100.

In the fixing device 100, the paper sheet P on which an unfixed toner image is formed is applied with pressure and heated by the control of the controller 21, and the fixing processing of the toner image to the paper sheet P is thus performed.

The paper sheet P that has been subjected to the fixing processing is transported to a sheet loading part, which is not illustrated, after passing through a curl correction part 81 provided in the sheet discharge section 1C.

### Description of Fixing Device 100

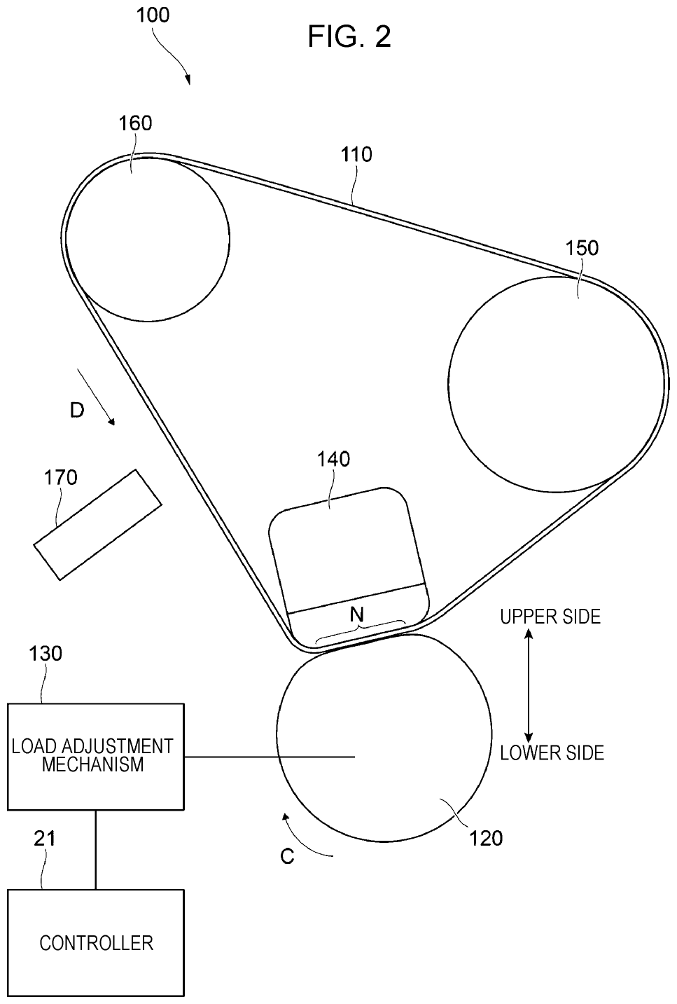

FIG. 2 illustrates the fixing device 100 of the present exemplary embodiment and is an enlarged view of the fixing device 100 illustrated in FIG. 1. As FIG. 2 illustrates, the fixing device 100 includes: a fixing belt 110 that is heated by a heat source and rotates; a pressing roller 120 that forms, with the fixing belt 110, a nip part N at a spot where the pressing roller 120 is in contact with the fixing belt 110, and applies pressure to a paper sheet P; and a load adjustment mechanism 130 that adjusts the load at the nip part N by moving the pressing roller 120 in the up-down direction. Note that an upward direction is a direction where the pressing roller 120 approaches the fixing belt 110, and a downward direction is a direction where the pressing roller 120 moves away from the fixing belt 110.

The fixing device 100 further includes: a pad 140 that forms, with the pressing roller 120, the nip part N with the fixing belt interposed therebetween and applies pressure to the paper sheet P together with the pressing roller 120; a heat roller 150 that is an example of the heat source and heats the fixing belt 110; and a steering roller 160 that imparts tension to the fixing belt 110. The fixing device 100 further includes a temperature sensor 170 that detects a belt temperature T of the fixing belt 110 before entering the nip part N.

The pressing roller 120 is rotated, by a motor, which is not illustrated, in accordance with the transport direction of a paper sheet P (a “C direction” in FIG. 2). The fixing belt 110 is rotated (in a “D direction” in FIG. 2) by being driven by the rotation of the pressing roller 120 in the C direction. The pressing roller 120 transports one by one the paper sheets P on which unfixed toner images are formed, to the nip part N, by driving and rotating together with the fixing belt 110. The unfixed toner image is fixed to the paper sheet P at the nip part N, by being heated by the fixing belt 110 and by being applied with pressure by the pressing roller 120 and the pad 140.

The load adjustment mechanism 130 obtains the belt temperature T from the temperature sensor 170. The belt temperature T is, for example, a surface temperature of the fixing belt 110. The load adjustment mechanism 130 is controlled by the controller 21, which has been described with reference to FIG. 1. The belt temperature T detected by the temperature sensor 170 is sent to the controller 21, and the controller 21 causes the load adjustment mechanism 130 to adjust the load at the nip part N according to the state of the sent belt temperature T.

The load adjustment mechanism 130 adjusts the load at the nip part N by moving the pressing roller 120 in the up-down direction. For example, the load adjustment mechanism 130 increases the load at the nip part N by moving the pressing roller 120 in the upward direction, which is the direction where the pressing roller 120 approaches the fixing belt 110, and the load adjustment mechanism 130 decreases the load at the nip part N by moving the pressing roller 120 in the downward direction, which is the direction where the pressing roller 120 moves away from the fixing belt. Note that the load adjustment mechanism 130 is configured, for example, by combining a motor and an eccentric cam structure.

A nip width of the nip part N is a width, in the transport direction of a paper sheet P, of a contact region of the pressing roller 120 and the fixing belt 110, and the width is at a spot where the pad 140 is provided. The shape of the surface of the pressing roller 120 is formed by an elastic layer, and the nip width varies depending on the load at the nip part N. For example, the nip width of the nip part N increases when the load adjustment mechanism 130 moves the pressing roller 120 in the upward direction, which is the direction where the pressing roller 120 approaches the fixing belt 110, and increases the load at the nip part N. For example, the nip width of the nip part N decreases when the load adjustment mechanism 130 moves the pressing roller 120 in the downward direction, which is the direction where the pressing roller 120 moves away from the fixing belt 110, and decreases the load at the nip part N.

### Load Adjustment of Load Adjustment Mechanism 130 According to State of Belt Temperature T

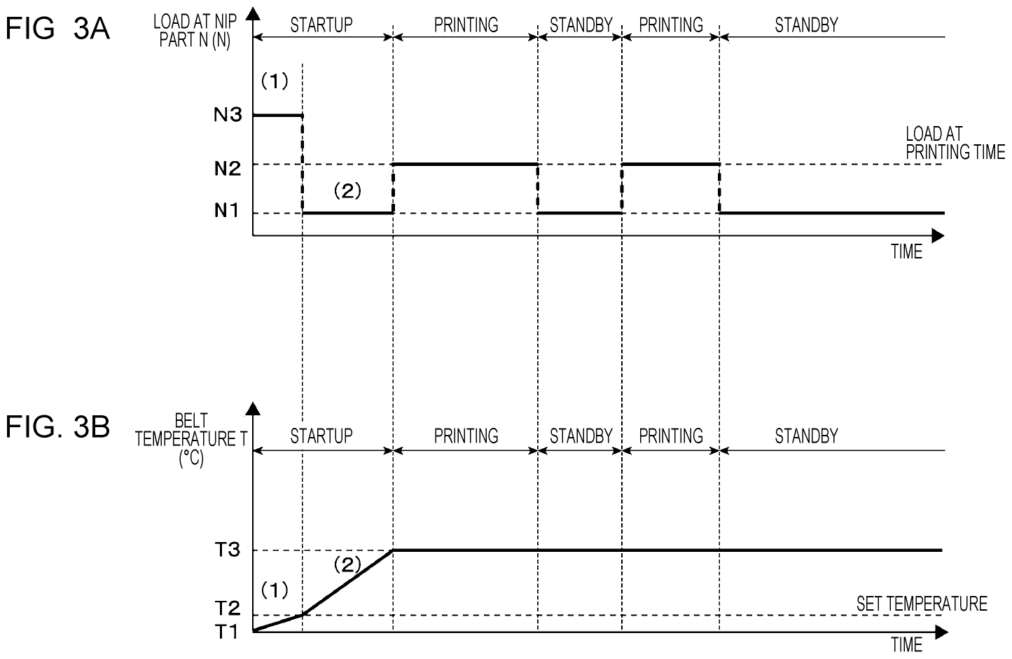

Next, the load adjustment of the load adjustment mechanism 130 according to the state of the belt temperature T will be described with reference to FIGS. 3A and 3B.

FIGS. 3A and 3B illustrate a procedure of adjustment of a load, performed by the load adjustment mechanism 130 of the present exemplary embodiment, according to the state of the belt temperature T. FIG. 3A illustrates variations in load caused by the load adjustment mechanism 130, and FIG. 3B illustrates the temperature variations of the belt temperature T.

The vertical axis of FIG. 3A represents the load at the nip part N that is changed by the load adjustment mechanism 130, and the lateral axis represents time. In the vertical axis, N1 to N3 each represent a predetermined load at the nip part N. The time of the horizontal axis includes a startup time from the power feed to an initial printing, a printing time during which the initial printing is performed after the startup time, and, subsequently, a standby time during which printing is held on standby, a next printing time, and a next standby time. The startup time is divided into a first startup time (1) during which the rotation of the pressing roller 120 and the driven rotation of the fixing belt 110 are started and a second startup time (2) between the end of the first startup time (1) and the initial printing. Note that FIG. 3A illustrates the states during the time from the first startup time (1) to an instant after a certain time has passed from the first startup time (1).

Of N1 to N3 given in the vertical axis, N1 is a low load that is determined for suppressing a decrease in the temperature of the fixing belt 110 without preventing the temperature from increasing. N2 is a load that is determined for fixing an unfixed toner image to a paper sheet P. N3 is a load that is determined for increasing the gripping strength of the pressing roller 120 relative to the fixing belt 110. The gripping strength is increased by using the load of N3, and slipping between the fixing belt 110 and the pressing roller 120 may thereby be suppressed. When N2, which is the load used when an unfixed toner image is actually fixed, is focused, N1 can be about ¼ to ⅔ times as large as N2, and N3 can be about 5/4 to twice as large as N2. Regarding actual loads of N1 to N3, for example, 30 newton (30 N) is selected for N1, 50 newton (50 N) is selected for N2, and 80 newton (80 N) is selected for N3.

The vertical axis of FIG. 3B represents the belt temperature T, and the lateral axis represents time. Startup, printing, and standby given in FIG. 3B correspond to those in FIG. 3A. T1 to T3 given in the vertical axis each represent the state of the belt temperature T. T1 represents the belt temperature, at the first startup time (1), that is changed from the temperature of the first action, such as room temperature, after a certain time has passed from the first action. T2 is a set temperature, which is a predetermined temperature, and represents the temperature at the change from the first startup time (1) to the second startup time (2). The set temperature is a predetermined temperature for making the fixing belt 110 having a dent or a bend flatter, and, when the belt temperature becomes T2, the influence of the slipping due to the dented or bent fixing belt 110 disappears or is reduced; thus, an increase of the belt temperature may have priority at the temperature. The controller 21 then recognizes that the belt temperature T has become T2, and causes the load adjustment mechanism 130 to decrease the load at the nip part N from N3 to N1. This decrease in the load at the nip part N may suppress heat dissipation, and the startup time may thus be reduced. T3 is a heating temperature when an unfixed toner image is fixed to a paper sheet P and represents the temperature at the printing time. The temperature T3 at the printing time is, for example, 150° C. to 200° C., and T2 can be determined to be about ½ times as high as T3, for example, about 100° C.

Next, the load adjustment of the load adjustment mechanism 130 according to the state of the belt temperature T will be described with reference to FIGS. 3A and 3B.

First, the first startup time (1) will be described. As FIG. 3B illustrates, at the first startup time (1), the belt temperature T is equal to or lower than T2 of the set temperature. At the first startup time (1), the dented or bent belt has not been made flatter. When the belt temperature T is equal to or lower than T2 of the set temperature, the load adjustment mechanism 130, which has been described with reference to FIG. 2, moves the pressing roller 120 in the upward direction, thereby increasing the load at the nip part N. As FIG. 3A illustrates, at the first startup time (1), the load at the nip part N is N3 and is higher than the load N2 of the printing time. By increasing the load at the nip part N to N3, the gripping strength of the pressing roller 120 relative to the fixing belt 110 is increased. Due to this, even when the dented or bent belt has not been made flatter, the slipping between the fixing belt 110 and the pressing roller 120 may be suppressed.

The transition from the first startup time (1) to the second startup time (2) will be described. As FIG. 3B illustrates, when the belt temperature T further increases after the first startup time (1), the belt temperature T becomes T2 of the set temperature. The set temperature T2 is a temperature that is a predetermined temperature for making the dented or bent fixing belt 110 flatter. The belt temperature T reaches T2 of the set temperature, and the load adjustment mechanism 130, which has been described with reference to FIG. 2, thereby moves the pressing roller 120 in the downward direction to decrease the load at the nip part N. Thus, as FIG. 3A illustrates, the load at the nip part N is changed from N3 to N1 and becomes lower than N2, which is the load of the printing time. As described above, in the present exemplary embodiment, the load at the nip part N is changed during the startup of the fixing device 100.

The second startup time (2) will be described. The second startup time (2) is a warm- up time during which the belt temperature T increases from T2 to T3 that is a temperature at which printing can be performed. At the second startup time (2), the load adjustment mechanism 130 decreases the load at the nip part N from N3 to N1, that is, the load adjustment mechanism 130 changes the load from N3, which is a load larger than the load N2 of the printing time, to N1, which is a load smaller than the load N2 of the printing time. Due to this, the nip width of the nip part N becomes smaller than that at the first startup time (1), and, at the second startup time (2), the heat conduction efficiency of the belt temperature T may become higher than that at the first startup time (1). That is, at the second startup time (2), from T2 to T3 that is a temperature at which printing can be performed, heat dissipation may be suppressed, and the belt temperature T may be easily increased; thus, the startup time may be reduced.

Next, the transition from the second startup time (2) to the printing time will be described. The printing of a paper sheet P is started in response to the increase of the belt temperature T to T3 during the second startup time (2). During the transition from the second startup time (2) to the printing time, the load adjustment mechanism 130, which has been described with reference to FIG. 2, moves the pressing roller 120 in the upward direction and increases the load at the nip part N until reaching the load of the printing time. As FIG. 3A illustrates, the load at the nip part N has increased from N1 to N2, which is the load of the printing time. In FIGS. 3A and 3B, the states of the belt temperature T and the load at the nip part N are changed from those at the startup time to those at the printing time. During the printing time, the belt temperature T is maintained to be T3, and the load at the nip part N is maintained to be N2.

Next, the standby time will be described. At the standby time during which printing is not performed, as FIG. 3B illustrates, the belt temperature T is equal to or higher than T2 of the set temperature. At the standby time, the load adjustment mechanism 130 makes the load at the nip part N lower than that at the printing time by moving the pressing roller 120 in the downward direction. As FIG. 3A illustrates, during the transition from the printing time to the standby time, the load at the nip part N decreases from N2, which is the load of the printing time, to N1. As describe above, by decreasing the load at the nip part N, at the standby time, the increased heat conduction efficiency of the belt temperature T may be maintained until the next printing time.

At the next printing time, the load adjustment mechanism 130 increases the load at the nip part N that is made lower than that at the printing time, to the load of the printing time by moving the pressing roller 120 in the upward direction. As FIG. 3A illustrates, the load at the nip part N has increased from N1 to N2, which is the load of the printing time.

As described above, in the present exemplary embodiment, adjusting the load at the nip part N according to the state of the belt temperature T may suppress the slipping between the fixing belt and the pressing roller at the startup time and may further reduce the heating time of the fixing belt.

The present exemplary embodiments have so far been described above; however, the present disclosure is not limited to the exemplary embodiments. For example, the load at the nip part N may be increased by moving the pad 140 in the up-down direction. In addition, the finer adjustment of the load at the nip part N can be set.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
A fixing device comprising:
a fixing belt that is heated by a heat source and rotates;
a pressing roller that forms a nip part at a spot where the pressing roller is in contact with the fixing belt, the pressing roller rotating; and
a load adjustment mechanism that obtains a belt temperature of the fixing belt and adjusts a load at the nip part according to a state of the belt temperature relative to a predetermined temperature.
   (((2)))
The fixing device according to (((1))), wherein,
when the belt temperature is equal to or lower than a predetermined temperature, the load adjustment mechanism makes a load at the nip part higher than a load of a printing time.
   (((3)))
The fixing device according to (((2))), wherein,
when the belt temperature reaches a predetermined temperature with a load at the nip part being made higher than the load of the printing time, the load adjustment mechanism makes a load at the nip part lower than the load of the printing time.
   (((4)))
The fixing device according to (((2))) or (((3))), wherein,
when printing is started, the load adjustment mechanism increases a load at the nip part that is made lower than the load of the printing time, to the load of the printing time.
   (((5)))
The fixing device according to (((1))), wherein
the load adjustment mechanism makes a load at the nip part lower than a load of a printing time if the belt temperature is equal to or higher than a predetermined temperature, and if printing is not performed.
   (((6)))
The fixing device according to (((5))), wherein,
when printing is started, the load adjustment mechanism increases a load at the nip part that is made lower than the load of the printing time, to the load of the printing time.
   (((7)))
The fixing device according to any one of (((1))) to (((6))), wherein
the load adjustment mechanism performs a change of a load at the nip part during startup of the fixing device.
   (((8)))
The fixing device according to any one of (((1))) to (((7))), wherein
the change of a load at the nip part is performed by changing a load that is larger than a load of a printing time to a load that is smaller than the load of the printing time.
   (((9)))
The fixing device according to any one of (((1))) to (((8))), wherein
the predetermined temperature is determined for making the fixing belt having a dent or a bend flatter.
   (((10)))
The fixing device according to (((1))), wherein
the nip part is formed by a pad that applies pressure on a paper sheet together with the pressing roller, and
the load adjustment mechanism adjusts a load at the nip part formed by the pad and the pressing roller between which the fixing belt is interposed.
   (((11)))
The fixing device according to (((1))), further comprising:
a temperature sensor that detects a belt temperature of the fixing belt before entering the nip part, wherein
the load adjustment mechanism adjusts a load at the nip part according to a state of the belt temperature detected by the temperature sensor.
   (((12)))
An image forming apparatus comprising:
a developer that develops an electrostatic latent image on a photoconductor;
a transfer part that transfers a developed image onto a paper sheet; and
a fixing device including:
   a fixing belt that is heated by a heat source and rotates;
   a pressing roller that forms a nip part at a spot where the pressing roller is in contact with the fixing belt, the pressing roller rotating; and
   an adjustment mechanism that obtains a belt temperature of the fixing belt and adjusts a load at the nip part according to a state of the belt temperature relative to a predetermined temperature,
the fixing device performing fixation of a paper sheet on which a developed image is transferred.

What is claimed is:

1. A fixing device comprising:
a fixing belt that is heated by a heat source and rotates;
a pressing roller that forms a nip part at a spot where the pressing roller is in contact with the fixing belt, the pressing roller rotating; and
a load adjustment mechanism that obtains a belt temperature of the fixing belt and adjusts a load at the nip part according to a state of the belt temperature relative to a predetermined temperature.

2. The fixing device according to claim 1, wherein,
when the belt temperature is equal to or lower than a predetermined temperature, the load adjustment mechanism makes a load at the nip part higher than a load of a printing time.

3. The fixing device according to claim 2, wherein,
when the belt temperature reaches a predetermined temperature with a load at the nip part being made higher than the load of the printing time, the load adjustment mechanism makes a load at the nip part lower than the load of the printing time.

4. The fixing device according to claim 3, wherein,
when printing is started, the load adjustment mechanism increases a load at the nip part that is made lower than the load of the printing time, to the load of the printing time.

5. The fixing device according to claim 1, wherein
the load adjustment mechanism makes a load at the nip part lower than a load of a printing time if the belt temperature is equal to or higher than a predetermined temperature, and if printing is not performed.

6. The fixing device according to claim 5, wherein,
when printing is started, the load adjustment mechanism increases a load at the nip part that is made lower than the load of the printing time, to the load of the printing time.

7. The fixing device according to claim 1, wherein
the load adjustment mechanism performs a change of a load at the nip part during startup of the fixing device.

8. The fixing device according to claim 7, wherein
the change of a load at the nip part is performed by changing a load that is larger than a load of a printing time to a load that is smaller than the load of the printing time.

9. The fixing device according to claim 1, wherein
the predetermined temperature is determined for making the fixing belt having a dent or a bend flatter.

10. The fixing device according to claim 1, wherein
the nip part is formed by a pad that applies pressure on a paper sheet together with the pressing roller, and
the load adjustment mechanism adjusts a load at the nip part formed by the pad and the pressing roller between which the fixing belt is interposed.

11. The fixing device according to claim 1, further comprising:
a temperature sensor that detects a belt temperature of the fixing belt before entering the nip part, wherein
the load adjustment mechanism adjusts a load at the nip part according to a state of the belt temperature detected by the temperature sensor.

12. An image forming apparatus comprising:
a developer that develops an electrostatic latent image on a photoconductor;
a transfer part that transfers a developed image onto a paper sheet; and
a fixing device including:
a fixing belt that is heated by a heat source and rotates;
a pressing roller that forms a nip part at a spot where the pressing roller is in contact with the fixing belt, the pressing roller rotating; and
an adjustment mechanism that obtains a belt temperature of the fixing belt and adjusts a load at the nip part according to a state of the belt temperature relative to a predetermined temperature,
the fixing device performing fixation of a paper sheet on which a developed image is transferred.

13. A fixing device comprising:
a fixing belt that is heated by a heat source and rotates;
a pressing means for forming a nip part at a spot where the pressing means is in contact with the fixing belt, the pressing means rotating; and
a load adjustment means for obtaining a belt temperature of the fixing belt and for adjusting a load at the nip part according to a state of the belt temperature relative to a predetermined temperature.
